(19) United States
(12) Patent Application Publication
(10) Pub. No.: US 2015/0089052 A1
(43) Pub. Date: Mar. 26, 2015

(54) Context-Aware HTTP Compression

(71) Applicants: Qun Yang Lin, Beijing (CN); Jun Qing Xie, Beijing (CN)

(72) Inventors: Qun Yang Lin, Beijing (CN); Jun Qing Xie, Beijing (CN)

(21) Appl. No.: 14/397,419

(22) PCT Filed: May 4, 2012
(86) PCT No.: PCT/CN2012/075102

§ 371 Date: Oct. 27, 2014

(51) Int. Cl. H04L 29/08; H04L 12/26

(52) U.S. Cl. CPC H04L 67/02; H04L 43/08
USPC 709/224

(57) ABSTRACT

A system, method, and non-transitory computer readable medium for context-aware HTTP compression in an intercepting network device between a plurality of web servers and a plurality of web browsers are provided. A context collection module gathers a plurality of contexts and a decision making module evaluates a plurality of rules with the plurality of contexts to determine whether to compress content. A content compression module compresses the content selected for compression by the decision making module.

### BACKGROUND

The Internet and the World Wide Web (“the web”) have revolutionized the ways in which content is disseminated and shared. At any given time, the web enables users to access multimedia content through connections to web pages and web sites displayed by web browsers on a number of electronic devices. These devices may include, for example, personal computers, laptops, tablets, phones, gaming devices, personal digital assistants, and so on. The web browser fetches the content from a web server using a protocol such as the HyperText Transfer Protocol (“HTTP”).

With the amount of content transferred from web servers increasing at a rapid pace, modern web browsers have implemented HTTP compression to reduce the number of bytes transferred and thus improve performance and provide users with a better web experience. HTTP compression uses public domain algorithms to encode content at the web server side and also enables web browsers to decode the compressed content automatically at the client side. The drawback is that HTTP compression is a computationally intensive operation. it is often not feasible to compress all content at a web server as HTPP compression may require too many processor resources and drastically degrade the performance of the whole system.

As a result, it has become increasingly common to offload HTTP compression functionality to a web accelerator or an intercepting network device such as, for example, a web proxy server or an Application Delivery Controller (“ADC”). The intercepting network device sits between the web servers hosting the content and the web browsers displaying the content to the users. It receives content requests from the web browsers and relays them to the web servers. Similarly, corresponding responses from the web servers are intercepted by the device before being delivered to the web browsers. Deciding whether or not to perform HTTP compression on the content remains a challenge. An appropriate HTTP compression decision can be critical to the performance of the device and the web experience in general.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 is a schematic diagram illustrating an example environment in which the various embodiments may be implemented;

FIG. 2 is a flowchart for compressing content with example Context-Aware HTTP Compression module 100 of FIG. 1;

FIG. 3 illustrates an example Context-Aware HTTP Compression module in more detail;

FIG. 4 is a flowchart for applying system rules to determine whether to compress a set of contents;

FIG. 5 illustrates a flowchart for compressing selected contents according to contexts and rules; and

FIG. 6 is a block diagram of an example intercepting network device for implementing the Context Aware Compression module of FIG. 3 according to various embodiments.

### DETAILED DESCRIPTION

A system, method, and non-transitory computer readable medium for providing context-aware HTTP compression are disclosed. As generally described herein, HTTP compression refers to the ability to compress content before it is sent from a web server to a web browser. The content may be compressed at the web server or at an intercepting network device (e.g., web proxy server, ADC, etc.) and may include text, images, audio, video, or any combination of multimedia content.

In various embodiments, a context-aware HTTP compression module is implemented at an intercepting network device. Context-aware, as generally used herein, refers to the ability to leverage information about a user, device, application, network, or environment in order to improve the quality of the user experience. The context-aware HTTP compression module has a context processing module to gather context information at the intercepting network device and use the context information to decide which content to compress based on a set of rules. The context information may include, but is not limited to, content and application context, system context, and network context, among others. The rules may include, but are not limited to, user-defined rules and system built-in rules. An operation module performs the HTTP compression using standard HTTP compression techniques (e.g., GZIP, Deflate, etc.) and delivers the compressed or uncompressed content to the web browsers. It should be noted that the context-aware HTTP compression module does not need any modification to existing intercepting network devices, web servers or web browsers.

It is appreciated that embodiments described herein below may include various components and features. Some of the components and features may be removed and/or modified without departing from a scope of the system, method, and non-transitory computer readable medium for providing context-aware HTTP compression. It is also appreciated that, in the following description, numerous specific details are set forth to provide a thorough understanding of the embodiments. However, it is appreciated that the embodiments may be practiced without limitation to these specific details. In other instances, well known methods and structures may not be described in detail to avoid unnecessarily obscuring the description of the embodiments. Also, the embodiments may be used in combination with each other.

Reference in the specification to “an embodiment,” “an example” or similar language means that a particular feature, structure, or characteristic described in connection with the embodiment or example is included in at least that one example, but not necessarily in other examples. The various instances of the phrase “in one embodiment” or similar phrases in various places in the specification are not necessarily all referring to the same embodiment. As used herein, a component is a combination of hardware and software executing on that hardware to provide a given functionality.

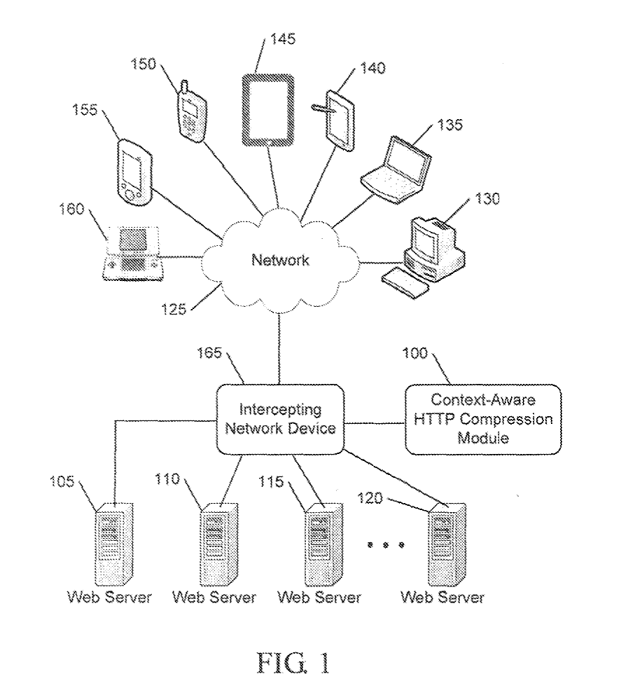

Referring now to FIG. 1, a schematic diagram illustrating an example environment in which the various embodiments may be implemented is described. Multimedia content is stored in a number of web servers, such as, for example, web servers 105-120. The content is sent to web browsers accessed by uses at a number of electronic devices connected to a wired and/or wireless network 125, including, but not limited to, a personal computer 130, a laptop 135, a personal digital assistant 140, a tablet 145, a phone 150, a smart phone 155, and a video gaming device 160. The web browsers receive the multimedia content from the web servers 105-120 via an intercepting network device 165, which may be, for example, a web proxy server, an ADC, a web accelerator, or any other such device.

A Context-Aware HTTP Compression module 100 implemented in the intercepting network device 165 and described in more detail herein below gathers context information to decide which multimedia content to compress before sending it off to web browsers at the electronic devices 130-160. The goal is to provide a better web experience to users. By selectively compressing the multimedia content delivered to users at electronic devices 130-160, the Context-Aware HTTP Compression module 100 provides greater compression throughout and hence higher performance.

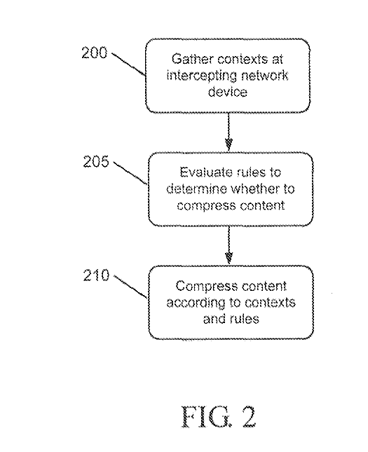

A flowchart for compressing content with the example Context-Aware HTTP Compression module 100 of FIG. 1 is illustrated in FIG. 2. First, the Context-Aware HTTP Compression module 100 gathers various contexts at the intercepting network device 165. Next, the module 100 evaluates a set of rules (e.g., user-defined rules and system built-in rules) to determine whether to compress content stored in web servers 105-120 before sending it to users at electronics devices 130-160 (205). Once the rules are evaluated and decisions are made on which content to compress, the selected content is compressed according to the contexts and the rules (210).

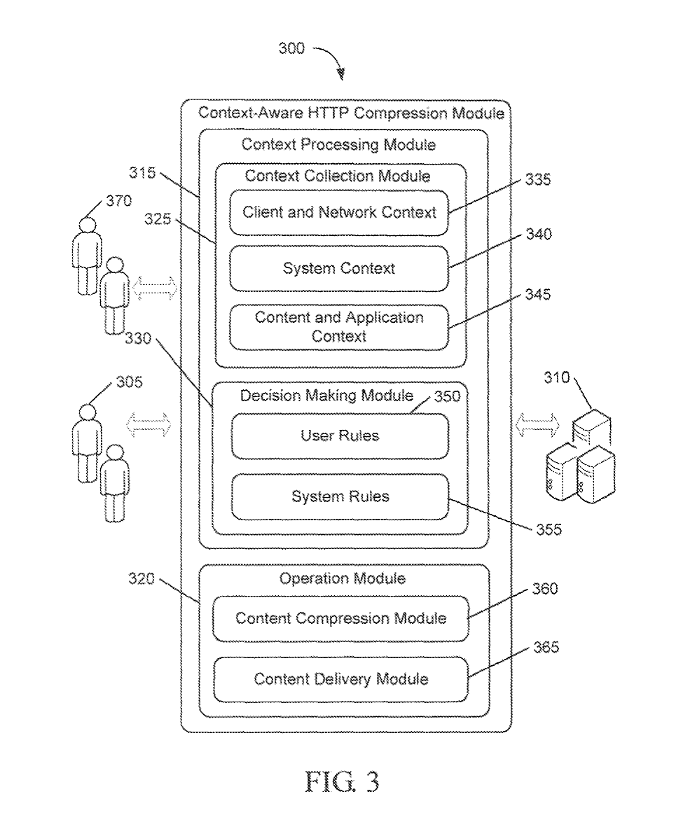

FIG. 3 illustrates an example Context-Aware HTTP Compression module in more detail. Context-Aware HTTP Compression module 300 can be implemented in a intercepting network device between web browser users 305 and web servers 310 to perform context-aware HTTP compression on content transmitted from the web servers 310 to the web browser users 305. The Context-Aware HTTP Compression module 300 has two main modules: (1) a Context Processing module 315 and (2) an Operation module 320.

The Context Processing module 315 gathers context information in a Context Collection module 325 and decides whether or not to compress the content based on rules (e.g., user-defined and system built-in rules) in a Decision Making module 330. The context information gathered by the Context Collection module 325 may include, but not be limited to, Client and Network Context 335, System Context 340, and Content and Application Context 345.

Each context may be represented as a specific variable to be used in rule definition and execution by the Decision Making module 330. The type of variable can be number (e.g., context length), string (e.g., client type), and so on. It is appreciated that the contexts 335-345 may be just a sample of a number of contexts that may be gathered by the Context Processing module 315. The Context Processing module 315 is an extensible module that may cover other context information as desired.

The Client and Network Context 335 includes information that identifies the type of connection (e.g., a high latency and/or low-bandwidth connection) to a web browser client (e.g., to users 305) requesting content from a web server (e.g., servers 310) via the intercepting network device. The information included in the Client and Network Context 335 may be, for example, an initial Round-Trip Time (“RTT”) and user-agent information.

As appreciated by one skilled in the art, the initial RTT of a dial-up network is usually larger than 100 ms and the initial RTT of a 3G mobile communications network is around 200 ms (the value of a 2G mobile communication network is usually 500 ms-800 ms), while the initial RTT of a broadband network is much smaller. Further, since HTTP identifies client software originating a content request by a user-agent header (even when the client is not operated by a user), the user-agent information may be used to identify the connection type. For example, if the user-agent information indicates that the corresponding web browser client is being used in a mobile device, and the initial RTT associated with the network connection of this user is relatively large (e.g., 200 ms), then the Client and Network Context 335 may identify the connection as from a mobile communication network.

The System Context 340 includes information about the intercepting network device processing web content through it. The information may include, for example, CPU load, compression throughput, and queue length, among others. The CPU utilization can be obtained via system interfaces (e.g., the proc files in a Linux OS). The compression throughput may be estimated accurately with System Rules 355 in Decision Making Module 330. The queue length indicating memory consumption and processing status can be obtained by calculating the total amount of buffering content. The Content and Application Context 345 information may be gathered from the header and body of the HTTP message and the TCP and IP header of the packets of the corresponding message.

It is appreciated that additional contexts (besides the Client and Network Context 335, the System Context 340, and the Content and Application Context 345 shown in FIG. 3) may be implemented in Context Processing Module 315. For example, a context collection plug-in may be implemented for the Context Processing Module 315 to get the specific context value. In doing so, corresponding context variables may need to be defined in the Decision Making Module 330 so that when it interprets the variables in the Decision Making Module 330 rules, it can find the value of the variables collected by the context collection plug-in.

The decision whether to compress the content is made in the Decision Making Module 330 by evaluating a sequence of rules, including User Rules 350 and System Rules 355. The User Rules 350 are specified by the system administrator(s) 370. Each rule may take the form of “if (conditions) then action”. The conditions may be regular expressions consisting of various context variables determined by the contexts in the Context Collection module 325, variable operations (e.g., number and string operations) and compound operations (e.g. and, or etc.). The action may include three filtering operations: BYPASS (do not need compression), NEXT (check the next rule) and ADD (add to a compression candidates set). An example of a user defined rule is as follows:
if (http.header.content_type.contains(“image”)) then BYPASS;
   This rule specifies that if the HTTP header contains an image, then no compression is needed. Once the User Rules 350 are applied and a set of compression candidates is formed, the System Rules 355 are used to evaluate which of the compression candidates are to be compressed.

The selected contents in the set of compression candidates are then compressed in the Content Compression Module 360 of the Operation Module 320 and sent to users 305 by the Content Delivery Module 365. It is appreciated that the Content Compression Module 360 may use the standard HTTP compression method defined in the HTTP/1.1 specification to compress the contents or any other such compression method. It is also appreciated that the Content Delivery Module 365 may use the standard HTTP protocol or any other such protocol to relay content requests from web users 305 to web servers 310 and deliver the requested contents (compressed or not) to the web users 305.

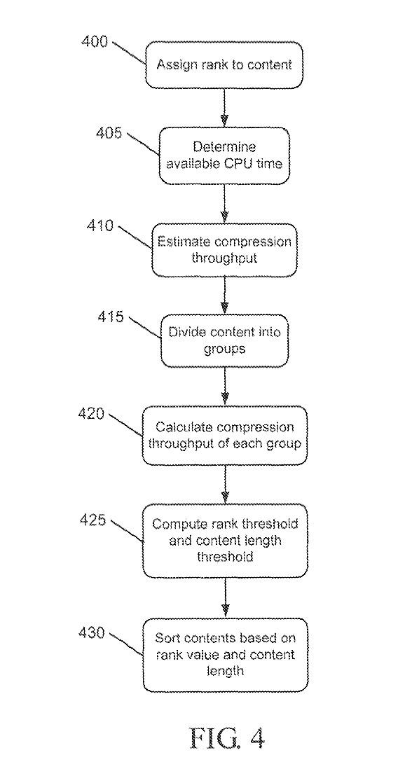

Referring now to FIG. 4, a flowchart for applying system rules to determine whether to compress content in a set of compression candidates is described. First, each of the contents in the set of compression candidates is assigned a rank value which indicates its priority (400). For example, content from high latency and/or low-bandwidth users (e.g. dial-up users, mobile communication users) may be assigned a higher rank than other types of content. Meanwhile, the CPU utilization is gathered periodically to calculate the available CPU time TC (405). The compression throughput is then estimated (410).

The contents in the set of compression candidates are divided into several groups according to their content length (415), Let N denote the number of compression groups. N computational threads in the intercepting network device (e.g., intercepting network device 165) may be created, each of which is responsible for compressing the content of its corresponding group. The compression throughput of a given group can then be calculated (420).

Let Cᵢ denote the compression throughput of the group i. CGᵢ denote the total compression amount of the group i, and TGᵢ denote total consumption CPU time of the thread corresponding to the group i. Then Cᵢ may be computed as Cᵢ=CG_{i/TG}ᵢ. Next, the rank threshold (indicated by RankThr) and the content-length threshold (indicated by ContentThr) can be determined (425) as shown in the pseudo code below:

| | |
|---|---|
| 1. | 0 SUM ← 0 |
| 2. | j ← 0 |
| 3. | Val ← CO_{M} |
| 4. | RankThr ← 0 |
| 5. | While SUM < TC and j ≦ M |

| | |
|---|---|
| a. | do SUM ← SUM + COⱼ/C(j) |
| b. | if SUM ≧ TC |

| | |
|---|---|
| 1. | then |

| | |
|---|---|
| a. | Val ← COⱼ |
| b. | RankThr ← Rank(j) |

| | |
|---|---|
| 2. | else |

| | |
|---|---|
| a. | j ← j + 1 |

| | |
|---|---|
| 6. | ContentThr ← Val |

where M denotes the total number of contents in the set of compression candidates, COⱼ denotes the length of the j-th content, C(j) denotes the compression throughput of the compression group which the j-th content belongs to, and Rank(j) denotes the rank value of the j-th content.

Once the RankThresh and the ContentThr are determined, the contents are sorted in descending order according to their rank values. The contents with the same rank value are sorted in descending order according to their content length (430). The Content Compression Module 360 in the Operation Module 320 checks each of the contents and decides whether to compress it based on its rank and the rank and content length thresholds RankThresh and the ContentThr,

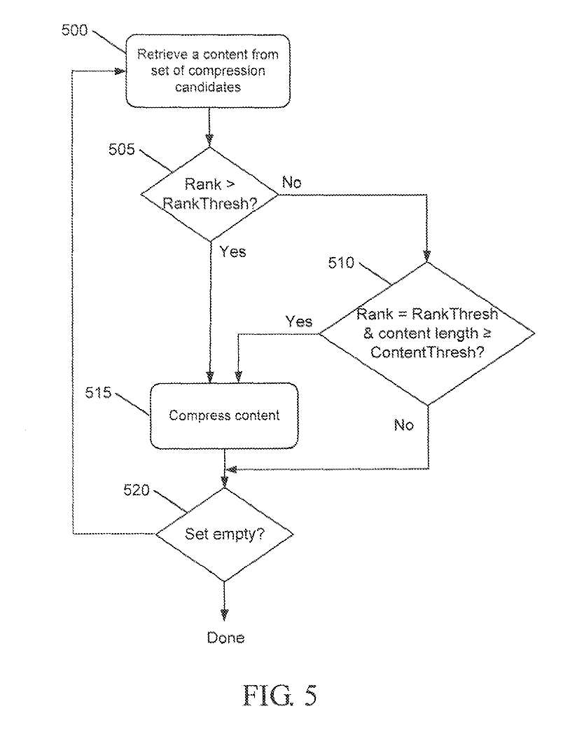

FIG. 5 illustrates a flowchart for compressing selected contents according to contexts and rules. First, a content item is retrieved from the set of compression candidates (500). The rank of the content item is compared against the RankThresh (505). If the content item is bigger than the RankThresh or its rank is the same as the RankThresh and its length is bigger than or equal to the ContentThresh (510), the content item is selected to be compressed by the Content Compression Module 360 (515). This process repeats until all content items have been retrieved from the set of compression candidates and the set is empty (520).

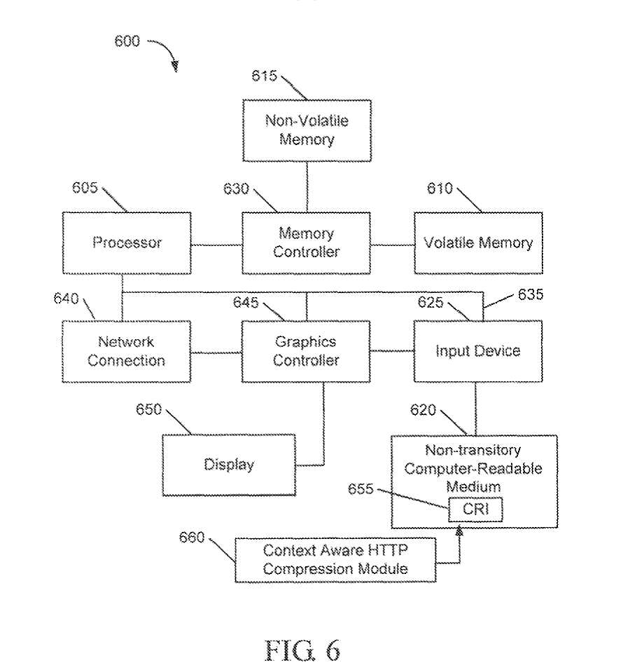

It is appreciated that the Context-Aware HTTP Compression module 300 of FIG. 3 7 can be implemented in hardware, software, or a combination of both. FIG. 6 illustrates a component for implementing the Context-Aware HTTP Compression module 300 of FIG. 3 in an intercepting network device according to the present disclosure. The intercepting network device 600 can include a processor 605 and memory resources, such as, for example, the volatile memory 610 and/or the non-volatile memory 615, for executing instructions stored in a tangible non-transitory medium (e.g., volatile memory 610, non-volatile memory 615, and/or computer readable medium 620). The non-transitory computer-readable medium 620 can have computer-readable instructions 655 stored thereon that are executed by the processor 605 to implement a Context-Aware HTTP Compression Module 660 according to the present disclosure.

As used herein, the processor 605 can include one or a plurality of processors such as in a parallel processing system. The memory can include memory addressable by the processor 605 for execution of computer readable instructions. The computer readable medium 620 can include volatile and/or non-volatile memory such as a random access memory (“RAM”), magnetic memory such as a hard disk, floppy disk, and/or tape memory, a solid state drive (“SSD”), flash memory, phase change memory, and so on. In some embodiments, the non-volatile memory 615 can be a local or remote database including a plurality of physical non-volatile memory devices.

The processor 605 can control the overall operation of the intercepting network device 600. The processor 605 can be connected to a memory controller 630, which can read and/or write data from and/or to volatile memory 610 (e.g., RAM). The processor 605 can be connected to a bus 635 to provide communication between the processor 605, the network connection 640, and other portions of the intercepting network device 600. The non-volatile memory 615 can provide persistent data storage for the intercepting network device 600. Further, the graphics controller 645 can connect to an optional display 650.

Each intercepting network device 600 can include a computing device including control circuitry such as a processor, a state machine, ASIC, controller, and/or similar machine. As used herein, the indefinite articles “a” and/or “an” can indicate one or more than one of the named object. Thus, for example, “a processor” can include one or more than one processor, such as in a multi-core processor, cluster, or parallel processing arrangement.

Advantageously, the Context-Aware HTTP Compression module (e.g., module 300, module 660) disclosed herein leverages more context information than simply the content context used in currently available systems. Here, system, network and application/content contexts are considered together to provide a more accurate compression decision. Further, the Context-Aware HTTP Compression module supports an easy context extension to include more context information into consideration when necessary through a context collection plug-in mechanism.

In addition, the Context-Aware HTTP Compression module improves compression performance. The most important metric of performance when measuring compression is throughput. The Context-Aware HTTP Compression module gives higher priority to compress the contents which can bring greater compression throughput. The Context-Aware HTTP Compression module also provides more selection to administrators as it supports user-defined rules (based on context variables) to give administrators more selection on candidate web contents to be compressed. Moreover, parameters like CPU power and working memory assigned to the Context-Aware HTTP Compression module are also configurable.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A context-aware HTTP compression module for use in an intercepting network device, comprising:
a context collection module to gather a plurality of contexts;
a decision making module to evaluate a plurality of rules with the plurality of contexts to determine whether to compress content; and
a content compression module to compress content selected for compression by the decision making module.

2. The context-aware HTTP compression module of claim 1, wherein the plurality of contexts comprises client and network context, system context, and content and application context.

3. The context-aware HTTP compression module of claim 1, wherein the plurality of contexts are specified in a plurality of context variables.

4. The context-aware HTTP compression module of claim 3, wherein the plurality of rules comprise user rules and system rules.

5. The context-aware HTTP compression module of claim 4, wherein the user rules comprise a plurality of “if (conditions) then action” rules wherein the conditions are based on the plurality of context variables.

6. The context-aware HTTP compression module of claim 5, wherein the action comprises an action selected from the group consisting of a bypass action, a next action, and an add action.

7. The context-aware HTTP compression module of aim 6, wherein the add action specifies a set of compression candidates.

8. The context-aware HTTP compression module of claim 4, wherein the system rules are based on a rank associated with the content, a compression throughput, and a content length.

9. The context-aware HTTP compression module of claim 8, wherein the system rules further comprise a rank threshold and a content length threshold.

10. The context-aware HTTP compression module of claim 9, wherein the content compression module compresses content having a rank higher than the rank threshold.

11. The context-aware HTTP compression module of claim 9, wherein the content compression module compresses content having a rank equal to the rank threshold and a content length larger or equal to the content threshold.

12. A method for context-aware HTTP compression implemented in an intercepting network device between a plurality of web servers and a plurality of web browsers, comprising:
gathering a plurality of contexts at the intercepting network device;
evaluating a plurality of rules based on the plurality of contexts to select content to compress; and
compressing the selected content cording to the plurality of contexts and the plurality of rules.

13. The method of claim 12, wherein the plurality of contexts comprises client and network context, system context, and content and application context.

14. The method of claim 12, wherein the plurality of rules comprise user rules and system rules.

15. The method of claim 14, wherein the user rules are based on the plurality of contexts.

16. The method of claim 13, wherein the client and network context comprises information that identifies a network connection between a web server and a web browser.

17. The method of claim 13, wherein the system context comprises information about the intercepting network device.

18. The method of claim 13, wherein the content and application context comprises information about the content.

19. A non-transitory computer readable medium having instructions stored thereon executable by a processor in an intercepting network device between a plurality of web servers and a plurality of web browsers to:
receive content from a web server;
gather a plurality of contexts;
apply a plurality of rules to determine whether to compress the content; and
compress the content based on the plurality of contexts and the plurality of

20. The non-transitory computer readable medium of claim 19, wherein the plurality of contexts comprises client and network context, system context, and content and application context.
